(19) United States
(12) Patent Application Publication
(10) Pub. No.: US 2012/0137494 A1
(43) Pub. Date: Jun. 7, 2012

(54) DEVICE FOR FASTENING AN ELEMENT OF ELONGATE SHAPE TO A TURBINE ENGINE CASING

(75) Inventors: Geoffray Deterre, Le Kremlin Bicetre (FR); Christian Henry Mazelle, Saclay (FR)

(73) Assignee: SNECMA, Paris (FR)

(21) Appl. No.: 13/389,530

(22) PCT Filed: Sep. 17, 2010
(86) PCT No.: PCT/FR2010/051933

§ 371 Date: Feb. 8, 2012

(30) Foreign Application Priority Data
Sep. 28, 2009 (FR) 09/04616

(51) Int. Cl. B23P 11/00; B23P 19/00

(52) U.S. Cl. 29/428; 29/700

(57) ABSTRACT

A device for fastening an element of elongate shape, such as an electrical harness or a duct, to a casing of a turbine engine. The device includes a tubular portion mounted around the element and secured to at least one tab for fastening to the casing, the tubular portion being made of a heat-shrink plastics material and configured to be heated to be shrunk onto the element.

The present invention relates to a device for fastening an element of elongate shape, such as for example an electrical harness or a fluid duct, to a structure of a machine, and in particular to a turbine engine casing.

An electrical harness is generally fastened to a turbine engine casing by means of a clamping collar that surrounds the harness and that includes a tab for fastening to the casing. A resilient ring is interposed between the harness and the collar in order to avoid damaging the harness when tightening the screw.

A device is also known for fastening an electrical harness to a casing, which device is generally a-shaped, having a curved portion surrounding the harness and connected at its ends to tabs for fastening to the casing by screw-and-nut type means.

The above-mentioned technologies nevertheless present numerous drawbacks. Each fastener device is suitable for engaging an electrical harness having some particular diameter and for fastening it to the casing, so it is necessary to have as many different references for fastener devices as there are different diameters of electrical harness fitted to the turbine engine.

Furthermore, known fastener devices are relatively heavy and they require a relatively long time for mounting. Furthermore, such fastener devices are independent of the harness and they can become separated from the harness in the event of the above-mentioned screws breaking or loosening.

An object of the invention is to remedy the above-mentioned drawbacks of the prior art in a manner that is simple, effective, and inexpensive.

To this end, the invention provides a device for fastening an element of elongate shape, such as for example an electrical harness or a duct, to a structure of a machine, in particular to a turbine engine casing, the device comprising a clamping portion for mounting around the element and secured to at least one tab for fastening to the casing, the device being characterized in that the clamping portion is tubular and made of a heat-shrink plastics material, said portion initially having an inside diameter that is greater than the outside diameter of the element so as to allow it to be mounted on the element, and being designed to be heated in order to be shrunk onto the element.

The tubular portion of the fastener device of the invention for clamping onto the element that is to be fastened is itself made of a heat-shrink plastics material, i.e. a plastics material that is designed to shrink under the effect of heat. This material is relatively lightweight compared with the metal material used for the devices of prior technologies. By way of example, the heat-shrink material may be Viton® or Teflon®, or the like.

The tubular portion of the device of the invention initially has an inside diameter that is relatively large so as to enable it to be engaged on an element for fastening that may have any diameter providing it is smaller than said inside diameter. The fastener device of the invention is thus adaptable to elements of different diameters, unlike prior technologies.

The tubular portion is designed to be shrunk by being heated so that it clamps onto the element. Once it has shrunk, the tubular portion can no longer return to its initial shape, thereby ensuring that the device is permanently fastened on the harness and thus avoiding any unwanted separation of the device from said element. It is nevertheless possible to remove the device from the element by cutting through its tubular portion over its entire length, e.g. using a blade, and then spreading apart its cut longitudinal edges.

According to another characteristic of the invention, the tubular portion of the device is a tube that is closed, i.e. not split, in particular in the longitudinal direction, thereby ensuring that the tubular portion is securely fastened on the element after said portion has been heat-shrunk.

In an embodiment of the invention, the fastener tab is made of heat-shrink plastics material and is made integrally with the tubular portion, thus enabling fabrication of the device of the invention to be facilitated.

In a variant, the fastener tab is constituted by a metal insert having a portion thereof embedded in the heat-shrink material of the tubular portion. The portion of the fastener tab that is embedded in the heat-shrink material may include means for anchoring it in the material.

The fastener tab may include at least one orifice for passing a screw, the orifice being oblong or elongate in shape in a transverse direction so as to accommodate possible assembly offsets between the device and the casing in this direction.

By way of example, the fastener tab extends substantially parallel to the longitudinal axis of the tubular portion of the device.

The present invention also provides an electrical harness or a duct for a turbine engine, the harness or duct being characterized in that it carries a fastener device of the above-specified type.

The invention also provides a turbine engine, such as an airplane turboprop or turbojet, the engine being characterized in that it includes a device as described above.

The invention also provides a method of fastening an element of elongate shape, such as for example an electrical harness or a fluid duct, to a structure of a machine, in particular to a casing of a turbine engine, the method being characterized in that it consists in engaging a fastener device of the above-specified type on said element, in heating the tubular portion of said device to shrink it until it is clamped onto the element, and then fastening the fastening tab of the device to the casing by means of at least one screw passing through an orifice of the tab.

The tubular portion of the device may also be fastened on the element by adhesive.

Finally, the present invention also provides a method of removing a fastener device as described above, the method being characterized in that it consists in cutting the tubular portion of the device over its entire length, and then withdrawing it from the element.

The invention can be better understood and other details, characteristics, and advantages of the present invention appear more clearly on reading the following description made by way of non-limiting example and with reference to the accompanying drawing, in which:

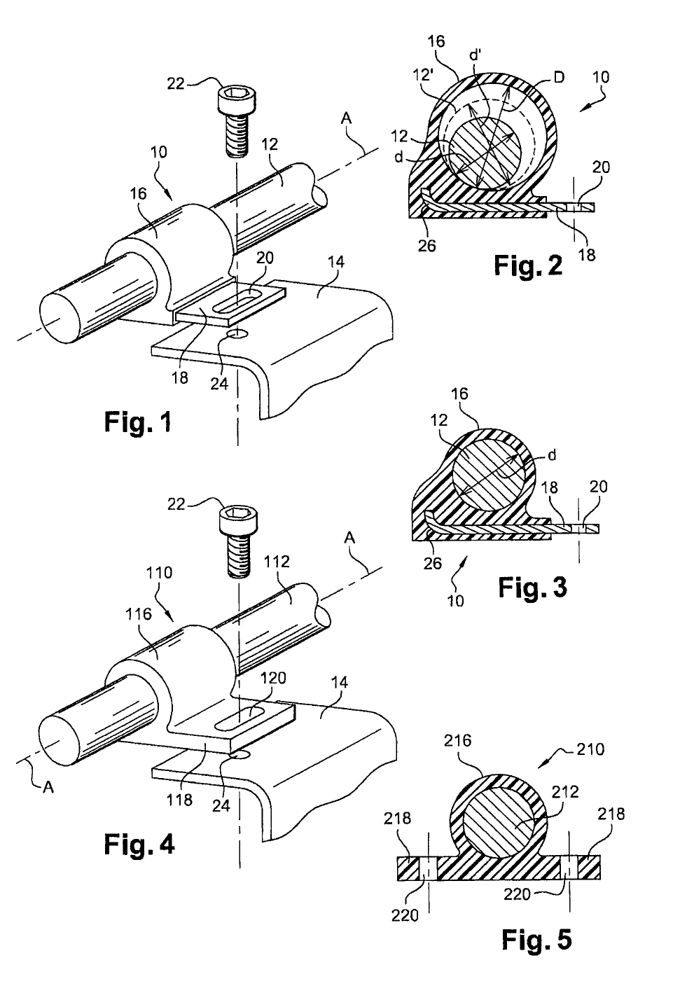

FIG. 1 is a diagrammatic perspective view of a device of the invention for fastening an element of elongate shape to a turbine engine casing;

FIGS. 2 and 3 are diagrammatic cross-section views of the FIG. 1 device and element for fastening, and they show steps in the method of mounting the device on the element;

FIG. 4 is a diagrammatic perspective view of a variant embodiment of the device of the invention; and

FIG. 5 is a diagrammatic cross-section view of another variant embodiment of the device of the invention.

Reference is made initially to FIG. 1, which shows an embodiment of the device 10 of the invention for fastening an element 12 of elongate shape to a casing 14 of a turbine engine, such as an airplane turboprop or turbojet, the device 10 comprising a tubular portion 16 that is engaged and clamped on the element 12 and that is secured to a tab 18 for fastening to the casing 14, the tubular portion 16 being made, according to the invention, out of a heat-shrink plastics material.

The element 12 may be an electrical harness or a fluid duct (for air, oil, or fuel), for example.

The fastener tab 18 in this example is formed by a plate or a flat metal insert having one end embedded in the heat-shrink material of the tubular portion 16. The tab 18 extends parallel to the longitudinal axis A of the tubular portion 16 (which coincides with the longitudinal axis of the element 12), substantially tangentially to the outer cylindrical surface of the tubular portion.

The tab 18 extends substantially over the entire length of the tubular portion 16, in a direction parallel to the axis A. The fastener tab 18 is securely anchored in the heat-shrink material of the tubular portion 16 which is overmolded on the tab 18. To do this, the end 26 of the tab that is embedded in the material may itself be curved or folded, as can be seen in FIGS. 2 and 3, or it may include orifices that become filled with the heat-shrink material during overmolding.

The tab 18 includes an orifice 20 for passing a screw or bolt 22 that is for engaging in a corresponding orifice 24 in the casing 14 and for receiving a nut at its free end (not shown) or for being screwed directly into the orifice 24 of the casing.

The orifice 20 in the tab 18 is advantageously oblong or elongate in shape, with its axis extending parallel to the direction in which an offset may appear during assembly between the device 10 and the casing 14. In the example shown, the orifice 20 is elongate in shape in a direction parallel to the axis A, which means that an offset may appear in said direction on assembling the device 10 to the casing. In other words, the elongate or oblong shape of the orifice 20 serves to accommodate such an offset, which is a few millimeters at most.

The way the device 10 of the invention is assembled on the element 12 is described below with reference to FIGS. 3 and 4.

In FIG. 2, the device 10 is shown in its initial state, prior to being shrunk by being heated. The tubular portion 16 then has an inside diameter D that is greater than the outside diameter d of the element 12 onto which the device is to be fastened. This portion 16 may be engaged on an element of any diameter (as represented diagrammatically by the element 12′ of outside diameter d′ greater than d), this diameter nevertheless necessarily being less than the above-mentioned diameter D.

The device 10 is applied to an end of the element 12 and is then moved along the axis A until the fastener tab 18 is situated in a predetermined position.

The tubular portion 16 of the device is then heated so as to be shrunk and clamped onto the element 12, as can be seen in FIG. 3. In this shrunk position, the inside diameter of the portion 16 is no greater than the outside diameter d of the element 12.

The device 10 is then prevented from moving on the element 12 by the clamping force between the tubular portion 16 and said element. The fastening of the device 10 on the element may be made stronger by adhesive between the tubular portion 16 and the element, the adhesive being situated between the inside cylindrical surface of the portion 16 and the element, and being placed on said surface prior to the above-mentioned heating step.

The variant embodiment of the device 110 of the invention that is shown in FIG. 4 differs from the above-described device 10 in that the fastener tab 118 is formed integrally with the tubular portion 116 and is therefore likewise made of heat-shrink plastics material.

The tab 118 is substantially plane and extends parallel to the longitudinal axis A of the tubular portion 116 (which coincides with the axis of the element 112). The tab 118 also has an orifice 120 of oblong shape for passing a screw 22 for fastening the device to the casing 14.

In the other variant embodiment shown in FIG. 5, the tubular portion 216 is integral with two tabs 218 that extend on either side of the portion 216 in a common plane that is substantially parallel to the axis of the tubular portion, so that the fastener device is substantially Ω-shaped. Each tab 218 has an orifice 220 for passing a screw for fastening to a turbine engine casing.

The devices 10, 110, and 210 of the invention may be removed from the elements 12, 112, and 212 by cutting off their tubular portions 16, 116, and 216 using a blade such as a cutter in a direction parallel to the axis A along the entire length thereof. It then suffices to spread apart the cut longitudinal edges of the tubular portion through a distance that is greater than the diameter of the element, and to withdraw the device from the element.

1-11. (canceled)

12. A device for fastening an element of elongate shape to a structure of a machine, the device comprising:
a clamping portion for mounting around the element and secured to at least one tab for fastening to a casing,
wherein the clamping portion is tubular and made of a heat-shrink plastics material, the clamping portion initially having an inside diameter that is greater than the outside diameter of the element so as to allow it to be mounted on the element, and configured to be heated to be shrunk onto the element.

13. A device according to claim 12, wherein the fastener tab is made of heat-shrink plastics material and is made integrally with the tubular portion.

14. A device according to claim 12, wherein the fastener tab includes a metal insert having a portion thereof embedded in the heat-shrink material of the tubular portion.

15. A device according to claim 14, wherein a portion of the fastener tab that is embedded in the heat-shrink material includes means for anchoring it in the material.

16. A device according to claim 12, wherein the fastener tab includes at least one orifice for passing a screw, the orifice being oblong or elongate in shape in a transverse direction so as to accommodate assembly offsets between the device and the casing in this direction.

17. A device according to claim 12, wherein the tubular portion is not split in the longitudinal direction.

18. An element of elongate shape, which carries a fastener device according to claim 12.

19. A turbine engine, comprising at least one fastener device according to claim 12.

20. A method of fastening an element of elongate shape, to a structure of a machine, the method comprising:
engaging a fastener device according to claim 12 on the element;
heating the tubular portion of the device to shrink it until it is clamped onto the element; and
then fastening the fastening tab of the device to the casing by at least one screw passing through an orifice of the tab.

21. A method according to claim 20, wherein the tubular portion of the device is also fastened on the element by adhesive.

22. A method of removing a fastener device according to claim 12 from an element of elongate shape, the method comprising:
cutting the tubular portion of the device over its entire length, and then withdrawing it from the element.
